(19) United States
(12) Patent Application Publication
(10) Pub. No.: US 2016/0027461 A1
(43) Pub. Date: Jan. 28, 2016

(54) METHOD FOR FORMING PARTICLE LAYER AND METHOD FOR MANUFACTURING MAGNETIC RECORDING MEDIUM

(71) Applicant: KABUSHIKI KAISHA TOSHIBA, Tokyo (JP)

(72) Inventors: Akira WATANABE, Kawasaki Kanagawa (JP); Kaori KIMURA, Yokohama Kanagawa (JP); Tsuyoshi ONITSUKA, Hino Tokyo (JP)

(21) Appl. No.: 14/549,472

(22) Filed: Nov. 20, 2014

(30) Foreign Application Priority Data
Jul. 24, 2014 (JP) 2014-150664

(51) Int. Cl. G11B 5/74; G11B 5/733; G11B 5/73; G11B 5/842

(52) U.S. Cl. CPC G11B 5/746; G11B 5/842; G11B 5/733; G11B 5/7325

(57) ABSTRACT

A method for forming a particle layer includes covering surfaces of particles with a first polymer, covering a surface of a substrate with a second polymer having a same skeletal structure as the first polymer, and applying a liquid in which the particles covered with the first polymer are dispersed, onto the surface of the substrate covered with the second polymer.

### CROSS-REFERENCE TO RELATED APPLICATION

This application is based upon and claims the benefit of priority from Japanese Patent Application No. 2014-150664, filed Jul. 24, 2014, the entire contents of which are incorporated herein by reference.

### FIELD

Embodiments described herein relate generally to a method for forming a particle layer, and a method for manufacturing a magnetic recording medium.

### BACKGROUND

In some conventional processes, a fine structure arranged at an interval of several nm to several hundred nm is applied to a magnetic recording medium, a semiconductor device, a photonic crystal, an antireflection film, or an adsorptive substrate. In order to form such a structure, a method for drawing a pattern on a resist using a drawing apparatus employing electron beam or ultraviolet ray, a method using a self-organizing phenomenon of a diblock copolymer or particles, and the like are used. In particular, in the method using particles, an inorganic material, particularly, a metal can be used unlike the methods using the resist or the diblock copolymer, and in a subsequent transfer etching process, a preferable etching selection ratio can be set. However, when a particle layer is formed on a substrate, a crack may occur in the particle layer, and thus pitch of the particles may be non-uniform.

In order to arrange the particles closely, some techniques employ a dip coating method with which the particles are arranged closely according to capillary force. However, when the particles are arranged, the particles may move, and a crack may occur in the particle layer during the process.

For suppressing such a crack, the techniques employ a large amount of an organic stabilizer added to a liquid including the particles. By heating the liquid formed on a substrate, flatness is improved and arrangement of particles is facilitated. However, as the amount of organic stabilizer between the particles is not uniform, a distance between the particles may also be non-uniform. For this reason, uniform interaction between the particles may not occur, and thus the arrangement of the particles may be non-uniform.

### DESCRIPTION OF THE DRAWINGS

FIG. 1 is a graph showing a relationship between weight average molecular weight of a protecting group and a particle distance.

FIG. 2 illustrates an example of a coating process of a single particle layer by a dip coating method.

FIG. 3 is a partially enlarged view of FIG. 2.

FIGS. 4A to 4D illustrate an example of a manufacturing method of a magnetic recording medium according to an embodiment.

### DETAILED DESCRIPTION

Embodiments provide a desirable particle arrangement with small pitch dispersion.

In general, according to one embodiment, a method for forming a particle layer includes covering surfaces of particles with a first polymer, covering a surface of a substrate with a second polymer having a same skeletal structure as the first polymer, and applying a liquid in which the particles covered with the first polymer are dispersed, onto the surface of the substrate covered with the second polymer.

According to the coating method of the particle layer of the embodiment, the particles covered with the first polymer are dispersed in the liquid, and are coated on the substrate covered with the second polymer having a same skeleton as the first polymer, and thus the single particle layer having a preferable particle arrangement in the pitch dispersion is able to be reliably formed on the substrate.

According to another embodiment, a method for manufacturing a magnetic recording medium includes covering surfaces of particles with a first polymer, covering a surface of a substrate with a second polymer having a same skeletal structure as the first polymer, applying a liquid in which the particles with the first polymer are dispersed onto the surface of the substrate with the second polymer, removing the first polymer covering the surfaces of the particles on the substrate, and forming a magnetic recording layer on the particles on the substrate.

According to the manufacturing method of the magnetic recording medium of the embodiment, the particles covered with the first polymer are dispersed in the liquid, and are coated on the substrate covered with the second polymer having the same skeleton as the first polymer material, and thus the single particle layer obtaining an preferable particle arrangement in the pitch dispersion is able to be reliably formed on the substrate. In addition, the single particle layer functions as a seed layer, and the magnetic recording layer is formed on the seed layer, and thus the magnetic recording medium provided with the magnetic recording layer having a preferable fine pattern of the pitch dispersion is able to be obtained.

Particle

An average particle diameter of the particles used in the embodiment is approximately 1 nm to 1 μm. Many of the particles are in the shape of a sphere, and may be in the shape of a tetrahedron, a cuboid, an octahedron, a triangular prism, a hexagonal prism, a cylinder, or the like. When the particles are arranged most closely, the particles are preferably symmetrical. In order to increase the arrangement properties of the particles at the time of coating, it is preferable that particle diameter variance of the particles be small. There is a proportionate relationship between the diameter variance of the particles and orientation variance (the pitch variance), and for example, when the particle diameter variance is approximately 10%, the pitch variance in the single particle layer, which is formed by arranging the particles, is approximately 7%. When the particle diameter variance is approximately 15%, the pitch variance is 10%, and when the particle diameter variance is approximately 30%, the pitch variance is 17%. For this reason, the particle variance, that is, the particle diameter variance is preferably less than or equal to 15%, and more preferably less than or equal to 10%.

It is preferable that a material of fine particles be a metal or an inorganic matter, or a compound thereof. Specifically, for the material of the fine particles, Al, Si, Ti, V, Cr, Mn, Fe, Co, Ni, Zn, Y, Zr, Sn, Mo, Ta, W, Au, Ag, Pd, Cu, Pt, or the like is preferably used. In addition, an oxide, a nitride, a boride, a carbide, and a sulfide thereof, and the like can be used. The particle may be crystalline or may be amorphous. For example, the particle may be a core-shell type particle such as a structure where a circumference of Fe as a core is covered with FeOₓ (x=1 to 1.5). In the core-shell type particle, the core may be covered with a material that is different from the core, such as a structure in which SiO₂ covers a circumference of Fe₃O₄. Further, a surface of a metal core-shell type particle such as Co/Fe may be oxidized, and thus a structure of 3 or more layers such as Co/Fe/FeOₓ may be used. Insofar as a main component is any one of the components described above, for example, a compound such as Fe₅₀Pt₅₀, which is compounded with a noble metal such as Pt or Ag, may be used.

An arrangement of the fine particles is performed in a solution, and thus the fine particles provided with a protecting group described later are used in a state where the fine particles are stably dispersed in solution.

Protecting Group (First Polymer Material)

For the protecting group as the first polymer material, an organic material having a reactive functioning group such as a carboxy group or a thiol group in a terminal can be used.

In general, the carboxy group has high affinity with the particles of Al, Si, Ti, V, Cr, Mn, Fe, Co, Ni, Zn, Y, Zr, Sn, Mo, Ta, or W, and the thiol group high affinity with the particles of Au, Ag, Pd, Cu, or Pt. When an alloy of two types of metals is used, a reactive functioning group that has high affinity with the metal of which content is greater than that of the other metal is used. When composition ratios of the two metals are similar extent like Fe₅₀Pt₅₀, reactive functioning groups that have high affinity with either materials thereof are able to be used at the same time. In this case, it is considered that the carboxy group is bonded with a Fe side, and the thiol group is bonded with a Pt side.

The reactive functioning group of the protecting group is bonded with the fine particles, and thus a main chain of the protecting group is able to be used for particle distance adjustment or polarity adjustment for an arrangement. In general, the polarity is able to be described by using a solubility parameter (an SP value). For example, when the polarity is high like water the SP value is large, and when the polarity is low the SP value is small. In a surface of carbon (C) or silicon (Si), it is preferable that the SP value be less than or equal to 25 MPa^{1/2}. It is preferable that a main chain of the organic material be general hydrocarbon (CₙH₂ₙ₊₁) or hydrocarbon having at least one of a double bond and a triple bond, aromatic hydrocarbon including polystyrene, and polyesters or polyethers. For example, for an organic material having the carboxy group, capric acid, lauric acid, palmitic acid, and stearic acid which are saturated hydrocarbon, and palmitoleic acid, oleic acid, linoleic acid, and linolenic acid which are unsaturated hydrocarbon, can be used. Similarly, for an organic material having the thiol group, CₙH₂ₙ₊₁-thiol, CₙH₂ₙ-thiol, and the like can be used. In addition, for the main chain of the organic material, a polymer such as polyester or polyethylene, epoxy, polyurethane, polystyrene, and polypropylene can be used. As a process of reacting the protecting group later is used, the main chain that has a straight chain structure with small branches can be used. In particular, when the polystyrenes are used, the SP value is close to the value of a coating solvent, and thus resolvability and coating properties are desirable.

The protecting group not only broadens the particle distance, but also improves the arrangement of the particles. A physical space in which the particles are able to freely move is required for the arrangement of the particles when the solvent is dried. When the particle distance is narrow, an influence of the Van der Waals' force between the particles is strong, and thus motion of the particle may be hindered. In particular, when the particles are exposed without the protecting group, the particles are aggregated, and thus are not able to move. When the protecting group is bonded with the surface of the particle, the distance between the particles is broadened, and thus the influence of the Van der Waals' force between the particles becomes weak. Therefore, it is possible to improve the arrangement of the particles without hindering the motion of the particles.

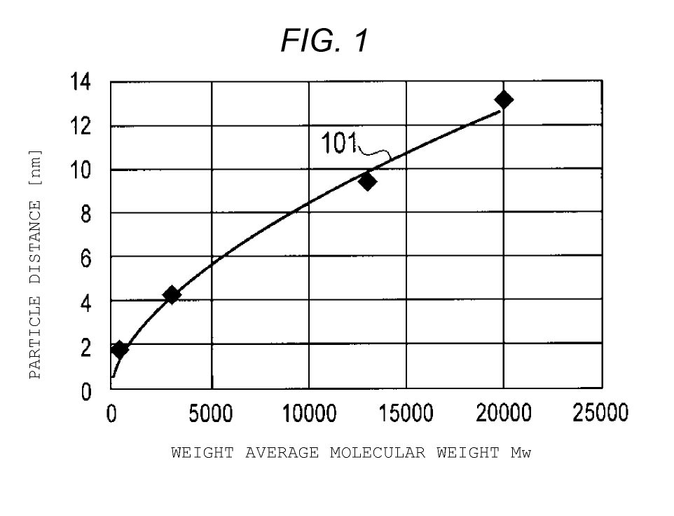

FIG. 1 is a graph illustrating a relationship between weight-average molecular weight of the protecting group and the particle distance when the protecting group is polystyrene.

As shown by 101 of FIG. 1, as the molecular weight of the protecting group increases, the particle distance increases.

When the particle is used as a recording pattern of a device such as a memory device or a storage device, for example, as the particle distance is broadened pattern density decreases. It is preferable that the particle distance be 10% to 200% with respect to a diameter of the particle. For this reason, the molecular weight of the protecting group is preferably in a range of 100 to 50,000. Further, it is preferable that polystyrene of which molecular weight is 1,000 to 50,000 be used as the first polymer material. Here, molecular weight which is not clearly specified is number-average molecular weight.

Substrate Treatment Agent (Second Polymer Material)

Preferably, the second polymer material, which is used as the substrate treatment agent, is preferably the same material as the protecting group (the first polymer material) for covering the surfaces of the particles. Specifically, it is preferable that a main chain of the organic material used for the substrate treatment agent be general hydrocarbon (CₙH₂ₙ₊₁) or hydrocarbon having at least one of a double bond and a triple bond, and aromatic hydrocarbon including polystyrene, polyesters, and polyethers are preferably used. For example, the main chain may be a polymer such as polyester, polyethylene, epoxy, polyurethane, polystyrene, and polypropylene. In a reaction between the substrate and the substrate treatment agent, a method for performing a hydrolysis reaction using a hydroxyl group, a silane coupling reaction, or the like is able to be used.

Molecular weight of the substrate treatment agent is not limited, but it is preferable that the molecular weight be 1,000 to 50,000. When there are few reaction groups in a substrate surface and the molecular weight of the substrate treatment agent is less than 3,000, coverage of the substrate surface is low and thus the arrangement of the particles is not desirable. For this reason, it is more preferable that the molecular weight be greater than or equal to 3,000.

More preferably, the second polymer material is polystyrene of which molecular weight is 1,000 to 50,000.

Further, by using the same or similar materials for the substrate treatment agent and the protecting group of the particles, an interaction between the particles and the substrate becomes strong, and thus it is possible to prevent a crack from occurring at the time of drying the solvent.

Here, the materials used for the substrate treatment agent and the protecting group for covering the surface of the particle may be a polymer having the same main part of the skeleton. When the protecting group for covering the surface of the particle is polystyrene, a material having a structure shown in Chemical Formulas (1) to (4) described later is able to be used for the substrate treatment agent.

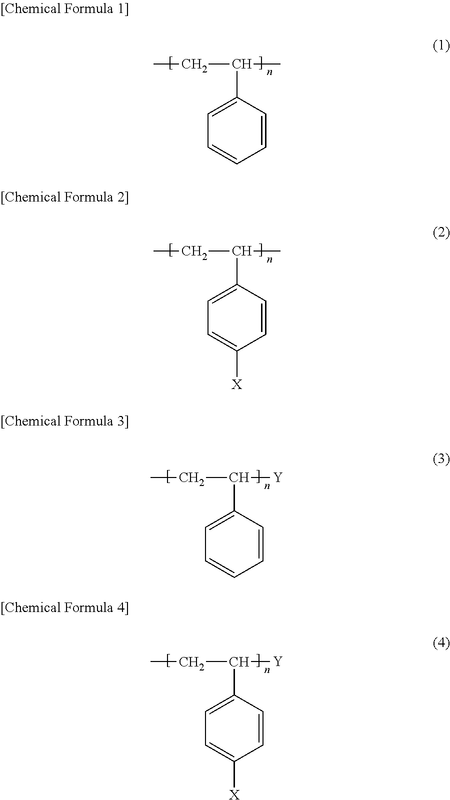

In Chemical Formulas described above, X is able to be various functioning groups. As such functioning groups, for example, an amino group, a hydroxyl group, a nitro group, a halogen group, and the like are included.

In addition, for Y in Chemical Formulas described above, a polymer in which a rate of a main polymer is greater than or equal to 50% as well as the same various functioning groups as X can be used. For example, for Y, polymethylmethacrylate (PMMA) and a block copolymer in which polystyrene (PS) and PMMA are bonded may be used.

Solvent

For the solvent in which the particles are dispersed, a solvent having high affinity with to the particle protecting group described above is preferably used. When the solvent coats the particles by a spin coating method, a solvent of which a boiling point is approximately 150° C. is preferable. When the solvent coats the particle by a dip coating method, a solvent of which boiling point is approximately 80° C. is preferable.

For example, when the spin coating method is used, xylene, cyclohexanone, propylene glycol monomethyl ether, butyl acetate, propylene glycol monomethyl ether acetate (PGMEA), diethylene glycol dimethyl ether, and the like are preferably used. In addition, when the dip coating method is used, hexane, methyl propyl ketone (MPK), methyl ethyl ketone (MEK), ethyl acetate, ethylene glycol dimethyl ether (DME), tetrahydrofuran (THF), cyclohexane, dichloroethane, and the like are preferably used. In particular, for the solvent used in the dip coating, a solvent having a chain structure is preferably used. For the solvent having the chain structure, for example, MPK, MEK, ethyl acetate, ethylene glycol dimethyl ether, and the like are used. Among the solvents having the chain structure, a solvent having a keton structure, for example, MPK, MEK, and ethyl acetate are preferable. Further, a solvent having relative dielectric constant of 10 or greater, for example, MPK, and MEK are more preferable.

In Table 1 below, covering properties of the particles, SP values, relative dielectric constants, and structure formulas of several solvents which are able to be used in the embodiments are shown.

Furthermore, the covering properties of the particles are able to be evaluated by an atomic force microscope (AFM) or a scanning electron microscope (SEM).

A case where a forming rate of the single particle layer on the substrate is greater than or equal to 90% is evaluated as “A”, a case where the rate is greater than or equal to 60% is evaluated as “B”, and a case where the rate is less than or equal to 60% is evaluated as “C”.

TABLE 1

| | | Sp | Relative | |
|---|---|---|---|---|
| | Covering | Value | Dielectric | Structure |
| Solvent | Properties | [MPa]^{1/2} | Constant | Formula |
| MEK | A | 19.0 | 15.5 | 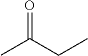 |
| Ethyl Acetate | B | 18.6 | 6.0 | 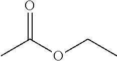 |
| 1,2- Dimethoxy- ethane | B | 17.6 | 7.2 | 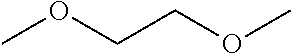 |
| 1,3- Dioxolane | C | 20.4 | 3.5 | 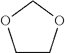 |
| THF | C | 18.6 | 7.5 | 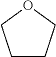 |
| Cyclohexane | C | 16.7 | 2.0 | 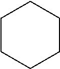 |
| 1,2- Dichloro- ethane | C | 20.0 | 10.7 | 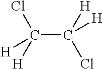 |

Coating Method

In order to coat the substrate with the particles, it is possible to use the spin coating method, the dip coating method, a Langmuir (L) method, or the like.

According to the spin coating method, particle coating liquid of which concentration is adjusted is dropped onto the substrate, and the substrate is rotated in order to dry the solvent. At this time, a film thickness is able to be adjusted in accordance with the number of rotations.

According to the dip coating method, the particle coating liquid of which concentration is adjusted is contained in a container, the substrate is dipped into the particle coating liquid in the container, and the fine particles are adhered onto the substrate by viscosity and intermolecular force at the time of pulling up the substrate. In addition, the film thickness is able to be controlled by adjusting a pulling-up speed. In the spin coating method, when the film thickness is controlled by adjusting the number of rotations, extra particle coating liquid is discarded. However, in the dip coating method, when the film thickness is controlled by adjusting the pulling-up speed, the extra particle coating liquid is returned to the container, and thus a discarded amount is smaller.

According to the L method, the polarity of the particle protecting group and the polarity of the solvent are disassociated, and a state in which the particles float on the surface by a single layer is formed, and then the fine particles are able to be arranged on the substrate by pulling up the dipped substrate.

Pulling-Up Speed

In Table 2 described below, evaluation of the covering properties of the particles formed is shown. Here, for the particle protecting group PS of which molecular weight is 5,000 was used, and for a surface treatment agent of a silicon substrate of 3 inches PS having the molecular weight of 14,000 was used. Using ethylene grycol dimethyl ether (DME) for the solvent and gold fine particles with a diameter of 10 nm for the particles, the particle coating liquid in which the concentration of gold fine particles was adjusted to 3 g/cc was prepared. Then, 100 substrates were pulled up from the particle coating liquid at different pulling-up speeds, and for evaluation of a yield, the number of samples in which there was no in-plane distribution among the 100 substrates was counted. The in-plane distribution was measured by using a spectroscopic ellipsometer in addition to an optical microscope, and it was determined that there was no film thickness distribution when the film thickness distribution was within ±10% in a region of 80% of the substrate.

TABLE 2

| Pulling-Up | | | Two or More | |
|---|---|---|---|---|
| Speed | 0 Layer | One Layer | Layers | |
| (mm/sec) | Portion | Portion | Portion | Yield |
| 20 | 20 | 0 | 80 | 0 |
| 15 | 20 | 10 | 70 | 27 |
| 10 | 15 | 20 | 65 | 51 |
| 8 | 15 | 30 | 55 | 63 |
| 5 | 10 | 50 | 40 | 82 |
| 3 | 10 | 65 | 25 | 100 |
| 1 | 10 | 70 | 20 | 100 |
| 0.8 | 5 | 85 | 15 | 100 |
| 0.5 | 0 | 100 | 0 | 98 |
| 0.3 | 0 | 100 | 0 | 75 |
| 0.1 | 0 | 100 | 0 | 54 |
| 0.08 | 0 | 100 | 0 | 30 |

In Table 3 described below, the covering properties of the particles formed are shown. Here, for the particle protecting group, PS of which molecular weight was 5,000 was used, and for the surface treatment agent of the silicon substrate of 3 inches, PS of which molecular weight was 14,000 was used. Using MEK for the solvent and gold fine particles with the diameter of 10 nm for the particles, the particle coating liquid of which concentration of the gold fine particles was 3 g/cc was prepared. Then, 100 substrates were pulled up from the particle solution liquid at different pulling-up speeds. In addition, for the evaluation of the yield, the number of samples in which there was no in-plane distribution among the 100 silicon substrates of 3 inches was counted.

TABLE 3

| Pulling-Up | | | Two or More | |
|---|---|---|---|---|
| Speed | 0 Layer | One Layer | Layers | |
| (mm/sec) | Portion | Portion | Portion | Yield |
| 20 | 5 | 60 | 25 | 0 |
| 15 | 5 | 80 | 15 | 16 |
| 10 | 0 | 100 | 0 | 58 |
| 8 | 0 | 100 | 0 | 68 |
| 5 | 0 | 100 | 0 | 86 |
| 3 | 0 | 100 | 0 | 100 |
| 1 | 0 | 100 | 0 | 100 |
| 0.8 | 0 | 100 | 0 | 100 |
| 0.5 | 0 | 100 | 0 | 95 |
| 0.3 | 0 | 100 | 0 | 72 |
| 0.1 | 0 | 100 | 0 | 62 |
| 0.08 | 0 | 100 | 0 | 32 |

In the Tables, it is shown that the yields of both solvents of DME and MEK in a range in which the pulling-up speed is 0.1 mm/sec to 10 mm/sec are greater than or equal to 50%. In addition, the yield in a range in which the pulling-up speed is 0.5 mm/sec to 5 mm/sec is 80%, and this range is more preferable.

When the pulling-up speed is faster than 10 mm/sec, the solvent is completely dried after the substrate is pulled out, and thus an influence of a disturbance such as an air current is received, and as a result, the yield and the covering properties of the particle are low. On the other hand, when the pulling-up speed is slower than 0.1 mm/sec, it takes along time for pulling up the substrate, and a liquid surface is fluctuated according to the influence of the disturbance which occurs during pulling up the substrate, and thus the yield is low.

Hereinafter, the exemplary embodiments will be described with reference to the drawings.

### Example 1

### Preparation of Particle Coating Liquid

As described below, the particle coating liquid is prepared.

First, the protecting group composed of polystyrene (PS) was formed on the particle surface.

Dispersion liquid of Au particles (an average particle size of 10 nm) including a decanethiol terminal group produced by Aldrich Co. LLC in toluene as a solvent was prepared. The dispersion liquid of toluene and the Au particles was further diluted with toluene, and particle solution A of which concentration was 0.1 wt % was prepared.

In addition, as the first polymer material, PS of which molecular weight was 5,000 and in which a thiol group (—SH group) was included in a terminal was prepared, and the PS was dissolved in toluene at the concentration of 1.0 wt %, and PS solution X was prepared.

Subsequently, mixing the particle solution A and the PS solution X at a volume ratio of 1:1, particle solution B was prepared, and the particle solution B was reacted at room temperature for 24 hours. According to this reaction, a surface of the Au particles including the decanethiol terminal reacted with the thiol group of the PS, and thus a PS layer was formed on the surface of the particles. After the reaction, ethanol which was a poor solvent of PS was mixed into the particle solution B, and the solvent and the particle were separated from each other using centrifugal separation, and thus the Au particles covered with the polystyrene was obtained as the first polymer material.

In order to redisperse the Au particles, 2-butanone (MEK) was used for a solvent, the Au particles were dissolved in MEK, and particle coating liquid C of which an Au particle concentration was 3 mg/cc was prepared.

Substrate Surface Treatment

Subsequently, a substrate surface treatment was performed.

For the substrate, an Si substrate of 3 inches was used, the substrate was cleaned by a UV cleaner for 10 minutes before being tested, and for a second polymer material, PS of which molecular weight was 9,800 and in which a hydroxyl group was included on a terminal was used. The PS was diluted with PGMEA at a concentration of 1 mass %, dropped on the substrate, and then a coating film was formed on the substrate using the spin coating method. Subsequently, a heat treatment was performed at 170° C. for 20 hours under a vacuum atmosphere, and a chemical adsorptive layer of PS was formed on the substrate. Subsequently, the PGMEA was dropped onto the substrate, surplus PS which was not used for chemical adsorption was dissolved, and the substrate was cleaned. Subsequently, the solvent was volatilized by a shaking off rotation, and thus a substrate including the PS chemical adsorptive layer on the surface was obtained. The film thickness of the chemical adsorptive layer was able to be adjusted by setting the molecular weight of the PS Here, the PS of which molecular weight was 9,800 was used, and the chemical adsorptive layer of which film thickness was 7.5 nm was formed.

As necessary, the same surface treatment may be performed on a back surface of the substrate.

Formation of Single Particle Layer

Next, the particle layer was formed by the dip coating method.

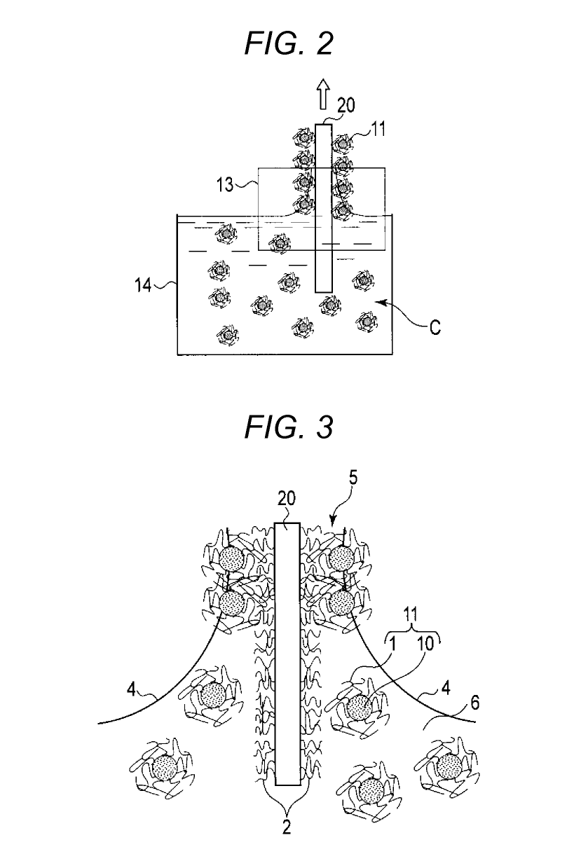

A schematic view of an example of a coating process of the single particle layer by the dip coating method is illustrated in FIG. 2.

A partially enlarged view of a region 13 in FIG. 2 is illustrated in FIG. 3.

As illustrated, the particle coating liquid C is contained in a container 14.

In the particle coating liquid C, particles 11 including Au particles 10 and a polystyrene protecting group 1 covering the surface of the Au particles 10 were dispersed in a solvent 6 (MEK).

A substrate 20 subjected to the surface treatment by coating a polystyrene covering layer 2 of which molecular weight was different from the material of the polystyrene protecting group was dipped vertically with respect to the liquid surface of the particle coating liquid C, and thus the entire substrate 20 was dipped. Subsequently, the substrate was stopped for 30 seconds in order to suppress the fluctuation of the liquid surface occurred at the time of dipping, and was pulled up at the pulling-up speed of 1 mm/sec, and then a particle layer 5 was formed on the entire substrate 20.

At this time, at the pulling-up speed of 1 mm/sec, the solvent was dried in a position pulled up by approximately 2 mm to 5 mm from a liquid surface 4, and an interference fringe occurred on the substrate according to the drying. After the interference fringe on the substrate disappeared and the solvent was dried, surface properties were confirmed by using the atomic force microscope (AFM), and thus it was confirmed that the single particle layer was formed in a range of 10 μm. In addition, the particle arrangement was confirmed by using the scanning electron microscope (SEM), and each of the particles was most closely filled, and it was shown that the pitch dispersion was 7.8%. According to the pulling-up speed, the film thickness (the number of layers) of the particle formed on the substrate is able to be controlled. If a multi-layer is formed on the substrate, it is possible to reduce an amount of the coating liquid on the substrate by decreasing the pulling-up speed, and if a region (a void) where there is no particle on the substrate is generated, it is possible to increase the amount of the coating liquid on the substrate by increasing the pulling-up speed, and thus it is possible to reduce the void. In addition, in the pulling up at the speed of 1 mm/sec, the layer formation is able to be improved by adjusting the concentration of the particle solution. For example, when the particle layer of the multi-layer is formed on the substrate, the concentration of the particle may be too low, and when the void is generated on the substrate, the concentration of the particle may be too high.

The particle layer formed by the dip coating method was prepared on the both surfaces of the substrate. In this Example, in a process of the substrate surface treatment, the surface treatment was performed only with respect to one surface of the substrate, and thus the single particle layer was formed on the surface subjected to the surface treatment, and a Si surface was exposed on a surface to which the surface treatment was not performed. Therefore, a region of the single particle layer was approximately 50% with respect to the entire region of the non-treatment surface.

Furthermore, separately, when a substrate subjected to a PMMA treatment was used, and coating solution using PMMA was used instead of the particle coating liquid C as the particle surface treatment. The covering properties of the particles after forming the particle layer were evaluated by the AFM, and it was shown that a rate of an area of a single particle layer portion (a one layer portion) to an area of the entire particle layer on the substrate was able to be set to 100% by performing the PMMA treatment as the substrate surface treatment.

### Comparative Examples 1-1 to 1-5

As Comparative Examples 1-1 to 1-5, an example in which materials of treated polymer layers on the particle surface and on the substrate surface are different from each other is described.

As the substrate, the single particle layer was formed by the same method as described in Example 1 except that a Si substrate subjected to UV cleaning and a Si substrate subjected to the surface treatment with polymethylmethacrylate (PMMA) were used. That is, PS was used for the protecting group of the particle surface.

As a result, it was shown that the substrate (Comparative Example 1-1) subjected to the PMMA treatment was able to be generally coated with the particles by one layer, but a void region where there was no particle and a multi-layer region where the particles were laminated appeared on the substrate. In addition, with respect to the UV cleaned substrate (Comparative Example 1-2), it was shown that the single particle layer portion decreased, and a multi-layer portion of 2 or more layers increased. The covering properties of the particles in a region of 30 μm×30 μm were evaluated by using the AFM, and ratios of a 0 layer portion (a void portion), the one layer portion (the single particle layer portion), and a two or more layers portion (the multi-layer portion) were measured.

The obtained result is shown in Table 4 below.

TABLE 4

| | Substrate | | | Two or More |
|---|---|---|---|---|
| | Surface | 0 Layer | One Layer | Layers |
| | Treatment Method | Portion | Portion | Portion |
| Example 1 | PS | 0 | 100 | 0 |
| Comparative | PMMA | 5 | 90 | 5 |
| Example 1-1 | | | | |
| Comparative | UV Cleaning | 30 | 50 | 20 |
| Example 1-2 | | | | |

The following three types of particle coating liquid were prepared.

The particle coating liquid was prepared by the same method as described in Example 1 except that decane was used instead of the polystyrene of the PS solution X.

In addition, the particle coating liquid was prepared by the same method as described in Example 1 except that PMMA was used instead of the polystyrene of the PS solution X.

Further, the particle coating liquid was prepared by the same method as described in Example 1 except that polyethyleneglycol (PEG) was used instead of the polystyrene of the PS solution X.

The respective particle coating liquids were applied onto the substrate which was subjected to the PS treatment, and the single particle layer was formed.

The covering properties of the formed particle were evaluated by the AFM. A result thereof is shown in Table 5 described below.

TABLE 5

| | | | | Two or More |
|---|---|---|---|---|
| | Protecting | 0 Layer | One Layer | Layers |
| | Group | Portion | Portion | Portion |
| Example 1 | PS | 0 | 100 | 0 |
| Comparative | PMMA | 5 | 90 | 5 |
| Example 1-3 | | | | |
| Comparative | Decane | 5 | 95 | 0 |
| Example 1-4 | | | | |
| Comparative | PEG | 10 | 70 | 20 |
| Example 1-5 | | | | |

### Comparative Example 2

As Comparative Example 2, an example where silica particles which are not covered with the polymer are used is described.

The particle layer was formed on the substrate by the same method as described in Example 1 except that the silica particle with a diameter of 50 nm in which the polymer material was not introduced onto the surface was used as the particle instead of the Au particle covered with the polystyrene. As a result thereof, it was confirmed that the formation of the single particle layer was less than or equal to 10% with respect to the entire substrate, and the other region was a multi-layer structure of 2 or more layers.

### Example 2

As Example 2, a case where the solvent for redispersing the Au particles is changed is described.

First, the protecting group composed of the polystyrene (PS) was formed on the particle surface by the same method as described in Example 1.

In order to redisperse the Au particles, the particle coating liquids were respectively prepared by the same method as described in Example 1 except that toluene, tetrahydrofuran (THF), ethyl acetate, methyl propyl ketone (MPK), MEK, 1,2-dichloroethane, 1,3-dioxolane, ethylene glycol dimethyl ether (DME), and cyclohexane were respectively used as the solvent. A boiling point of the solvent was approximately 60° C. to 90° C., which is an optimal boiling point for the dip coating.

Subsequently, similar to Example 1, the substrate which was subjected to the surface treatment with the PS was dipped into each of the particle coating liquids and pulled up, and thus the particle layer was formed on the substrate.

At this time, the concentration of the solution was 3 mg/cc, and the pulling-up speed was 1 mm/sec. This is a condition where the single particle layer is formed on the substrate at the time of using the MEK solvent which was used in Example 1.

In the condition described above, the covering properties of the particles were evaluated with respect to each of the substrate on which the particle layer was formed, using the AFM. Results thereof are shown in Table 6 below.

TABLE 6

| | 0 Layer | One Layer | Two or More |
|---|---|---|---|
| Solvent | Portion | Portion | Layers Portion |
| MPK | 0 | 100 | 0 |
| MEK | 0 | 100 | 0 |
| Ethyl Acetate | 5 | 90 | 5 |
| DME | 10 | 70 | 20 |
| Toluene | 40 | 30 | 30 |
| 1,3-Dioxolane | 30 | 0 | 70 |
| THF | 30 | 0 | 70 |
| Cyclohexane | 30 | 0 | 70 |
| 1,2-Dichloroethane | 0 | 0 | 100 |

From the result, it is shown that a single layer coating is possible with respect to MPK, MEK, ethyl acetate, and DME, which have the chain structure, at the pulling-up speed of 1 mm/sec. Among them, MPK, MEK, and ethyl acetate, which include keton in the structure, are preferable because the ratio of the one layer portion is higher, and further with respect to MPK and MEK, which have high dielectric constant, the one layer portion was formed on the entire substrate.

In order to coat the single layer of particles, the solvent having the chain structure and dissolving the protecting group for covering the particle can be used. When the particle protecting group is PS, the solvent having the chain structure and dissolving the PS can be used. Further, by using the solvent with the high dielectric constant, a zeta potential of the particle is improved, and the particles easily repel each other, and thus the single layer is easily formed. Among them, the solvent having the keton structure in the structure is preferable.

When the particle is covered with dodecane, which is alkane, it is possible to use hexane, which is a nonpolar material, for the solvent. It is possible to coat a large area on the substrate with the single layer. However, as the dielectric constant of hexane is low, it is not easy to form the particle layer of the single layer on the entire substrate at the pulling-up speed.

Furthermore, when DME and toluene are used as the solvent, setting the pulling-up speed in the range of 0.001 mm/sec to 0.1 mm/sec, the formation of the particle layer of the single layer with respect to the entire substrate may be greater than or equal to 80%.

In addition, when 1,3-dioxolane, THF, and cyclohexane are used as the solvent, it is possible to form the particle layer of the single layer at the pulling-up speed of 0.001 mm/sec to 0.01 mm/sec.

In contrast, when MPK and MEK are used, it is possible to form the particle layer of the single layer at the pulling-up speed of 0.001 mm/sec to 15 mm/sec.

### Example 3

As Example 3, an example where the molecular weight of the first polymer material, which is used for covering the particle, is changed is described.

The particle coating liquid was prepared by the same method as described in Example 1 except that the molecular weight of the first polymer material for covering the surface of the particle was different. PS of which molecular weight was changed from 1,000 to 20,000 was used for covering the particle. In order to completely cover the particle surface according to the change of the molecular weight, an added amount of PS was suitably changed.

The particle coating liquid was applied onto the substrate by the same method as described in Example 1, and the particle layer was formed.

The particle covering properties, a particle pitch, a standard deviation of the pitch were evaluated with respect to the obtained particle layer by using the AFM and SEM, respectively.

The obtained result is shown in Table 7 below.

TABLE 7

| | | | Two or More | | Standard |
|---|---|---|---|---|---|
| Molecular | 0 Layer | One Layer | Layers | Average | Deviation |
| Weight | Portion | Portion | Portion | Pitch (nm) | (nm) |
| 1000 | 5 | 80 | 15 | 14 | 1.8 |
| 3000 | 5 | 90 | 5 | 17 | 1.5 |
| 5000 | 0 | 100 | 0 | 20 | 0.9 |
| 7500 | 0 | 100 | 0 | 24 | 0.8 |
| 9800 | 0 | 100 | 0 | 26 | 0.9 |
| 15000 | 0 | 100 | 0 | 28 | 0.9 |
| 18500 | 0 | 100 | 0 | 29 | 0.8 |
| 20000 | 0 | 100 | 0 | 31 | 0.9 |

The pitch was different according to the molecular weight of PS for covering the particle. When the molecular weight is greater than or equal to 5,000, the standard deviation is less than or equal to 1 nm, and when the molecular weight of PS is less than 5,000, the standard deviation increases. Accordingly, it is shown that a distance between the particles is close to each other according to the decrease in the molecular weight, and the Van der Waals' force between the particles is strong, and thus the dispersion tends to be degraded by aggregation of the particles.

### Example 4

In Example 4, the particle coating liquid was prepared using the polymer of different molecular weights, and the Au particle layer was formed on the substrate by the same method as described in Example 3 except that an average particle diameter of the used Au particle was changed into 5 nm, and the concentration of the particle solution to be adjusted was different. PS of which molecular weight was changed from 1,000 to 20,000 was used for covering the particle. In order to completely cover the particle surface according to the molecular weight, the added amount of PS was suitably changed.

The particle solution was prepared by adjusting the concentration of the Au particle covered with PS in MEK to be 2 g/cc, and the dip coating was performed at the pulling-up speed of 1 mm/sec.

The particle covering properties, the particle pitch, and the standard deviation of the pitch were evaluated with respect to the particle layer formed on the substrate by using the AFM and the SEM, respectively. The obtained result is shown in Table 8 below.

TABLE 8

| | | | Two or More | | Standard |
|---|---|---|---|---|---|
| Molecular | 0 Layer | One Layer | Layers | Average | Deviation |
| Weight | Portion | Portion | Portion | Pitch (nm) | (nm) |
| 1000 | 5 | 90 | 5 | 7.5 | 1.2 |
| 3000 | 0 | 100 | 0 | 8.0 | 0.7 |
| 5000 | 0 | 100 | 0 | 8.3 | 0.8 |
| 7500 | 0 | 100 | 0 | 9.0 | 0.6 |
| 9800 | 0 | 100 | 0 | 9.2 | 0.7 |
| 15000 | 0 | 100 | 0 | 9.3 | 0.8 |
| 18500 | 0 | 100 | 0 | 9.4 | 0.9 |
| 20000 | 0 | 100 | 0 | 9.6 | 0.8 |

The pitch is changed according to the molecular weight of PS for covering the particle. When the molecular weight is greater than or equal to 3,000, the standard deviation is less than or equal to 1 nm, and when the molecular weight of PS is less than 3,000, the standard deviation increases. Unlike Example 3, as the Van der Waals' force between the particles is weak according to the decrease in the particle size, it is possible to improve the arrangement with the polymer having the molecular weight which is smaller than that of Example 3. On the other hand, when the particle size increases, in particular, when the particle size is greater than or equal to 30 nm, a covering with PS of which molecular weight is greater than or equal to 5,000 is preferable, and the covering with the polymer material of which molecular weight is greater than or equal to 10,000 is more preferable.

### Example 5

In Example 5, a case where the molecular weight of the polymer for covering the particle is changed is described. Example 5 was identical to Example 1 except that the molecular weight of the polymer for covering the substrate surface was changed. PS of which molecular weight was changed from 1,000 to 20,000 was used. According to Example 1, the particle covering properties, the particle pitch, and the standard deviation of the pitch were evaluated with respect to the particle layer formed on the substrate by using the AFM and the SEM, respectively. A result thereof is shown in Table 9.

TABLE 9

| Molecular | 0 Layer | One Layer | Two or More |
|---|---|---|---|
| Weight | Portion | Portion | Layers Portion |
| 1000 | 15 | 60 | 25 |
| 3000 | 5 | 70 | 25 |
| 5000 | 0 | 95 | 5 |
| 7500 | 0 | 100 | 0 |
| 9800 | 0 | 100 | 0 |
| 15000 | 0 | 100 | 0 |
| 18500 | 0 | 100 | 0 |
| 20000 | 0 | 100 | 0 |

The ratio of the one layer portion is changed according to the molecular weight of PS for covering the substrate. It is shown that when the molecular weight is greater than or equal to 5,000, the substrate of 90% or greater is covered with the particles of the one layer, and when the molecular weight decreases, the ratio of the one layer portion tends to decrease.

### Example 6

In Example 6, a case where the single particle layer formed by the dip coating method is used as a seed layer of the magnetic recording medium is described.

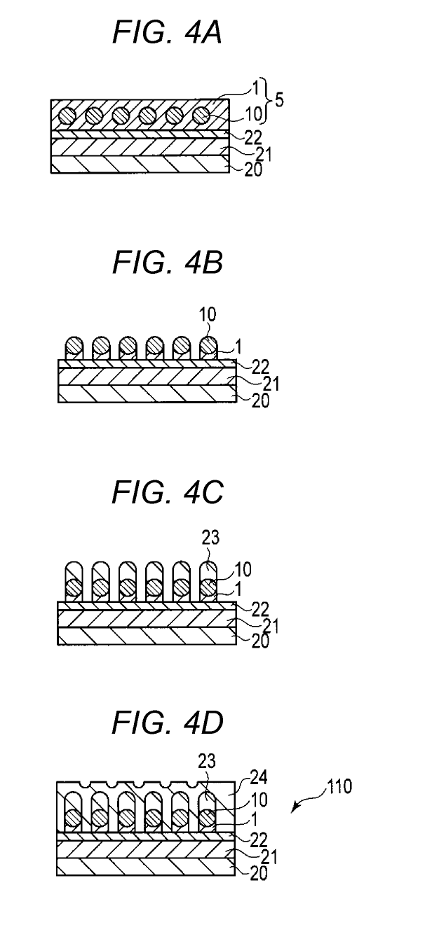

FIGS. 4A to 4D illustrate an example of a manufacturing method of the magnetic recording medium according to the embodiment.

For the substrate, a glass substrate, an Al-based alloy substrate, ceramics, a Si single crystal substrate including carbon or an oxidized surface, and the like are able to be used. Here, the glass substrate (an amorphous substrate MEL6 produced by Konica Minolta, Inc., a diameter of 2.5 inches) is used.

By using a DC magnetron sputtering system (C-3010 produced by Canon Anelva Corporation), the following film formation was performed on the substrate surface.

First, a soft magnetic layer 21 (CoZrNb) with a thickness of 40 was formed on the glass substrate 20, and a Si layer 22 of 3 nm was formed as the protective layer. Subsequently, the surface of the substrate 20 on which the soft magnetic layer 21 and the Si layer 22 were formed was hydrophilized by the UV cleaner. Subsequently, the substrate was dipped into PGMEA solution in which polystyrene with the molecular weight of 5,000 and the hydroxyl group as the second polymer material was dissolved at the concentration of 1.0 wt %, for 10 seconds, and was pulled up at the pulling-up speed of 1 mm/sec. Thus, a PS film was formed on the substrate surface as the first covering layer by the dip coating method. Subsequently, the substrate was heated at 170° C. for 20 hours, and the substrate surface was subjected to chemical adsorption of PS. Subsequently, the substrate was dipped into the PGMEA solution, and the surplus PS which did not react with the substrate was rinsed and cleaned.

The obtained substrate was dipped into the particle solution C which was prepared in Example 1, and the particle solution C was coated on the substrate at the pulling-up speed of 1 mm/sec, and thus, as illustrated in FIG. 4A, the particle layer 5 having a regular arrangement pattern provided with the particle 10 and the protecting group 1 placed around the particle 10 was formed. When a film thickness distribution of coated particles occurs due to a hole in the center of the substrate, it is possible to improve the film thickness distribution by decreasing the concentration of the particle solution and increasing the pulling-up speed to approximately 3 mm/sec. By adjusting the concentration and the pulling-up speed, the entire substrate can have the single particle layer.

As illustrated in FIG. 4B, by a dry etching, a protecting group 1 bonded around the particle 10 was etched, and the particles 10 were isolated. This process, for example, was performed by an induction coupled plasma (ICP) RIE apparatus in a condition where O₂ gas was used for process gas, a chamber pressure was 0.1 Pa, coil RF power and platen RF power were 100 W and 10 W, respectively, and an etching time was 10 seconds. As the Au particle 10 was hardly etched in O₂ plasma, the Au particle 10 was exposed on the substrate surface on which the Si layer 22 of the protective layer was formed. After the protecting group 1 around the particle 10 was etched, the Si layer 22 of the protective layer functioned as an etching stopper, and thus the etching was ended.

The substrate 20 on which the particle 10 was exposed was returned to a film forming apparatus (the DC magnetron sputtering system), and a magnetic recording layer 23 was deposited on the surface of the particle 10 after making a chamber of the apparatus vacuum. First, an Au layer of 5 nm for controlling crystalline orientation was formed, and a Ru layer of 10 nm was laminated in sequence, and then the Co₈₀Pt₂₀ magnetic recording layer 23 of 15 nm was laminated.

Then, a second protective layer 24 was formed by a chemical deposition method (CVD), and lubricant was coated. Then, a patterned medium 110 was obtained.

A planar structure of the patterned medium obtained by such a method described above was observed by the SEM, and a CoPt particle diameter dispersion was 8.0%. From this result, it was clear that the magnetic recording medium with low size dispersion was obtained from the fine pattern according to the embodiment.

With respect to the obtained perpendicular magnetic recording medium, recording reproduction properties were evaluated by using a read and write analyzer 1632 and a spin stand S1701MP produced by US GUZIK company. As a head for recording and reproduction, a single magnetic pole head with saturation magnetic flux density of approximately 2T was used in a recording unit and a head using gigantic magnetic resistance effects was used in a reproduction unit, respectively. In evaluation of a reproduction signal output to medium noise ratio (S/Nm), a reproduction signal output S used an amplitude in linear recording density of approximately 50 kFCI, and Nm used a square average value in the linear recording density of approximately 400 kFCI. As a result, spike-like noise was not observed on a front surface of a disc, and thus a preferable value such as the S/Nm of 19.8 dB was obtained. Further, a signal with the linear recording density of approximately 100 kFCI was recorded on the recording medium, and output deterioration due to thermal fluctuation was evaluated. A reproduction output was periodically observed for 100,000 seconds after ending a recording investigation, deterioration of the reproduction output was within a range of a measurement error, and a signal attenuation rate was approximately −0 dB/decade.

As the seed pattern, in addition to a method directly using the particle like Example 6, a processed layer of carbon or Si which is able to be etched in parallel with the protecting group etching is formed on the protective layer, and then the particle layer is formed, a pattern formed on the particle layer is transferred to the processed layer by the dry etching, and thus a rugged pattern of the obtained processed layer is able to be used as the seed pattern. In this case, the particle is peeled by a wet process after the dry etching, and thus it is possible to concurrently eliminate the particles which hinder a floating head, and it is possible to use a base layer of any material.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for forming a particle layer, comprising:
covering surfaces of particles with a first polymer;
covering a surface of a substrate with a second polymer having a same skeletal structure as the first polymer; and
applying a liquid in which the particles covered with the first polymer are dispersed, onto the surface of the substrate covered with the second polymer.

2. The method according to claim 1, wherein
the liquid is an organic material having a chain structure.

3. The method according to claim 2, wherein
the liquid has a keton structure, and
a relative dielectric constant thereof is equal to or greater than 10.

4. The method according to claim 3, wherein
the liquid is methyl ethyl ketone or methyl propyl ketone.

5. The method according to claim 1, wherein
the particles include an inorganic material containing at least one material selected from a group consisting of aluminum, silicon, titanium, vanadium, chromium, manganese, iron, cobalt, nickel, zinc, yttrium, zirconium, tin, molybdenum, tantalum, tungsten, gold, silver, palladium, copper, and platinum.

6. The method according to claim 1, wherein
a number average molecular weight of the second polymer is greater than that of the first polymer.

7. The method according to claim 1, wherein
the first polymer is polystyrene having a number average molecular weight of 1,000 to 50,000.

8. The method according to claim 1, wherein
the second polymer is polystyrene having a number average molecular weight of 1,000 to 50,000.

9. The method according to claim 1, wherein
the applying of the liquid is carried out by a dip coating method.

10. A method for manufacturing a magnetic recording medium, comprising:
covering surfaces of particles with a first polymer;
covering a surface of a substrate with a second polymer having a same skeletal structure as the first polymer;
applying a liquid in which the particles with the first polymer are dispersed, onto the surface of the substrate with the second polymer;
removing the first polymer covering the surfaces of the particles on the substrate; and
forming a magnetic recording layer on the particles on the substrate.

11. The method according to claim 10, wherein
the liquid is an organic material having a chain structure.

12. The method according to claim 11, wherein
the liquid has a keton structure, and
a relative dielectric constant thereof is equal to or greater than 10.

13. The method according to claim 12, wherein
the liquid is methyl ethyl ketone or methyl propyl ketone.

14. The method according to claim 10, wherein
the particles include an inorganic material containing at least one material selected from a group consisting of aluminum, silicon, titanium, vanadium, chromium, manganese, iron, cobalt, nickel, zinc, yttrium, zirconium, tin, molybdenum, tantalum, tungsten, gold, silver, palladium, copper, and platinum.

15. The method according to claim 10, wherein
a number average molecular weight of the second polymer is greater than that of the first polymer.

16. The method according to claim 10, wherein
the first polymer is polystyrene having a number average molecular weight of 1,000 to 50,000.

17. The method according to claim 10, wherein
the second polymer is polystyrene having a number average molecular weight of 1,000 to 50,000.

18. The method according to claim 10, wherein
the applying of the liquid is carried out by a dip coating method.

19. A magnetic recording medium comprising:
a substrate;
a particle layer that is disposed above the substrate and includes particles that are spaced apart from each other at an interval of hundred nanometers or less;
a magnetic recording layer having patterned portions, each being disposed above one of the particles; and
a layer between the substrate and the particle layer, the layer containing polymers of different types and having the same skeletal structure.

20. The magnetic recording medium according to claim 19, wherein
the first and second polymers are each polystyrene and have different molecular weights.
